(19) United States
(12) Patent Application Publication
(10) Pub. No.: US 2024/0275958 A1
(43) Pub. Date: Aug. 15, 2024

(54) METHOD AND APPARATUS FOR VIDEO CODING USING GEOMETRIC INTRA PREDICTION MODE

(71) Applicants: Hyundai Motor Company, Seoul (KR); Kia Corporation, Seoul (KR); Digitalinsights Inc., Seoul (KR)

(72) Inventors: Yong Jo Ahn, Seoul (KR); Jong Seok Lee, Seoul (KR); Jin Heo, Yongin (KR); Seung Wook Park, Yongin (KR)

(21) Appl. No.: 18/645,631

(22) Filed: Apr. 25, 2024

Related U.S. Application Data
(63) Continuation of application No. PCT/KR2022/013245, filed on Sep. 5, 2022.

(30) Foreign Application Priority Data
Oct. 25, 2021 (KR) 10-2021-0143104
Sep. 2, 2022 (KR) 10-2022-0111277

(51) Int. Cl. H04N 19/11; H04N 19/176; H04N 19/46

(52) U.S. Cl. CPC H04N 19/11; H04N 19/176; H04N 19/46

(57) ABSTRACT

A video coding method and a video coding apparatus are configured for video coding using a geometric intra-prediction mode. The video coding method and the video coding apparatus generate two intra predictors by using two different intra-prediction modes. The video coding method and the video coding apparatus use pixel-wise weights based on a geometric block partition to weight sum two intra predictors and thereby generate a final intra predictor.

### CROSS-REFERENCE TO RELATED APPLICATIONS

This application is a continuation of International Application No. PCT/KR2022/013245 filed on Sep. 5, 2022, which claims under 35 U.S.C. § 119(a) the benefit of Korean Patent Application No. 10-2021-0143104, filed on Oct. 25, 2021, and Korean Patent Application No. 10-2022-0111277, filed on Sep. 2, 2022, the entire contents of which are incorporated herein by reference.

### BACKGROUND

### (a) Technical Field

The present disclosure relates to a video coding method and a video coding apparatus using a geometric intra prediction mode.

### (b) Description of the Related Art

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/AVC, High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

An intra prediction technique when performing prediction for the current block, utilizes spatially adjacent neighbor pixels of the current block in the same picture to generate prediction signals. In conventional video encoding/decoding methods and devices, to improve the coding performance of intra prediction techniques, an increased number of intra-prediction modes are used or filtering is applied to the spatially adjacent neighbor pixels used for intra prediction. These intra prediction techniques as compared to the inter prediction technique have a relatively low performance of generating prediction signals due to the constraint of utilizing limited pixels in the same picture as the current block when generating the prediction signals.

To improve the prediction performance of the intra prediction, multiple line buffers may be utilized in addition to spatially adjacent pixels. For example, multiple reference line (MRL) intra prediction techniques select one or more lines of pixels located at a specific distance to perform intra prediction. There also exists a Matrix weighted Intra Prediction (MIP) technique that generates intra prediction signals by using a product operation between neighbor pixels and a predefined matrix. Therefore, to improve video coding efficiency and enhance video quality, there is a need for the intra prediction method to be improved further.

### SUMMARY

The present disclosure provides a video coding method and a video coding apparatus which, when applying a geometric intra-prediction mode, generate two intra predictors by using two different intra-prediction modes. The video coding method and the video coding apparatus use pixel-wise weights based on a geometric block partition to weight sum the two intra predictors and thereby generate a final intra predictor.

At least one aspect of the present disclosure provides a method performed by a video decoding apparatus for intra-predicting a current block. The method includes decoding, from a bitstream, a geometric intra-prediction flag that indicates whether to use a geometric intra-prediction mode for the current block and checking for the geometric intra-prediction flag. If the geometric intra-prediction flag is true, the method further includes decoding from the bitstream a geometric partitioning information index, a first intra-prediction mode index, and a second intra-prediction mode index. The method further includes selecting a first intra-prediction mode from a list of prediction modes by using the first intra-prediction mode index and generating, based on the first intra-prediction mode, a first intra predictor of the current block by using pixels spatially adjacent to the current block. The method further includes selecting a second intra-prediction mode from the list of prediction modes by using the second intra-prediction mode index and generating, based on the second intra-prediction mode, a second intra predictor of the current block by using pixels spatially adjacent to the current block. The method further includes obtaining, by using the geometric partitioning information index, weights that comprise first weights used for the first intra predictor and second weights used for the second intra predictor, and weight summing the first intra predictor and the second intra predictor by using the weights to generate a final intra predictor of the current block.

The method further includes generating the list comprising prediction modes for intra prediction of the current block.

Another aspect of the present disclosure provides a method performed by a video encoding apparatus for intra-predicting a current block. The method includes determining a geometric intra-prediction flag that indicates whether to use a geometric intra-prediction mode for the current block and checking for the geometric intra-prediction flag. If the geometric intra-prediction flag is true, the method further includes determining a geometric partitioning information index. The method further includes determining a first intra-prediction mode and determining, for the first intra-prediction mode, a first intra-prediction mode index from a list of intra-prediction modes. The method further includes generating, based on the first intra-prediction mode, a first intra predictor of the current block by using pixels spatially adjacent to the current block. The method further includes determining a second intra-prediction mode and determining, for the second intra-prediction mode, a second intra-prediction mode index from the list of intra-prediction modes. The method further includes generating, based on the second intra-prediction mode, a second intra predictor of the current block by using pixels spatially adjacent to the current block. The method further includes obtaining, by using the geometric partitioning information index, weights that comprise first weights used for the first intra predictor and second weights used for the second intra predictor, and weight summing the first intra predictor and the second intra predictor by using the weights to generate a final intra predictor of the current block.

If the geometric intra-prediction flag is true, the method further includes generating the list comprising intra-prediction modes for intra prediction of the current block.

Yet another aspect of the present disclosure provides a computer-readable recording medium storing a bitstream generated by a video encoding method. The video encoding method includes determining a geometric intra-prediction flag that indicates whether to use a geometric intra-prediction mode for a current block and checking for the geometric intra-prediction flag. If the geometric intra-prediction flag is true, the video encoding method further includes determining a geometric partitioning information index and generating a list comprising intra-prediction modes for intra prediction of the current block. The video encoding method further includes determining a first intra-prediction mode and determining, for the first intra-prediction mode, a first intra-prediction mode index from the list of intra-prediction modes. The video encoding method further includes generating, based on the first intra-prediction mode, a first intra predictor of the current block by using pixels spatially adjacent to the current block. The video encoding method further includes determining a second intra-prediction mode and determining, for the second intra-prediction mode, a second intra-prediction mode index from the list of intra-prediction modes. The video encoding method further includes generating, based on the second intra-prediction mode, a second intra predictor of the current block by using pixels spatially adjacent to the current block. The video encoding method further includes obtaining, by using the geometric partitioning information index, weights that comprise first weights used for the first intra predictor and second weights used for the second intra predictor, and weight summing the first intra predictor and the second intra predictor by using the weights to generate a final intra predictor of the current block.

As described above, the present disclosure provides a video coding method and an apparatus which, when applying a geometric intra-prediction mode, generate two intra predictors by using two different intra-prediction mode. The video coding method and the apparatus use pixel-wise weights based on a geometric block partition to generate a final intra predictor from the two intra predictors. Thus, the video coding method and the apparatus improve the video encoding efficiency and enhance video quality.

Furthermore, the present disclosure provides a video coding method and an apparatus for generating a final intra predictor from two different intra predictors by using pixel-wise weights. The video coding method and the apparatus, when applying a geometric intra-prediction mode, can utilize the effect of arbitrary block partitioning arising from a blending process that simulates a geometric block partition.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binary tree ternary tree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram illustrating an intra-predictor generation device, according to at least one embodiment of the present disclosure.

FIG. 7 is a diagram illustrating the application of a geometric intra-prediction mode, according to at least one embodiment of the present disclosure.

FIG. 8 is a diagram illustrating the blending processing of two predictors, according to at least one embodiment of the present disclosure.

FIG. 9A and FIG. 9B are illustrative diagrams depicting straight lines bisecting a block, according to at least one embodiment of the present disclosure.

FIG. 10 is a flowchart of an intra prediction method performed by a video encoding apparatus, according to at least one embodiment of the present disclosure.

FIG. 11 is a flowchart of an intra prediction method performed by a video decoding apparatus, according to at least one embodiment of the present disclosure.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

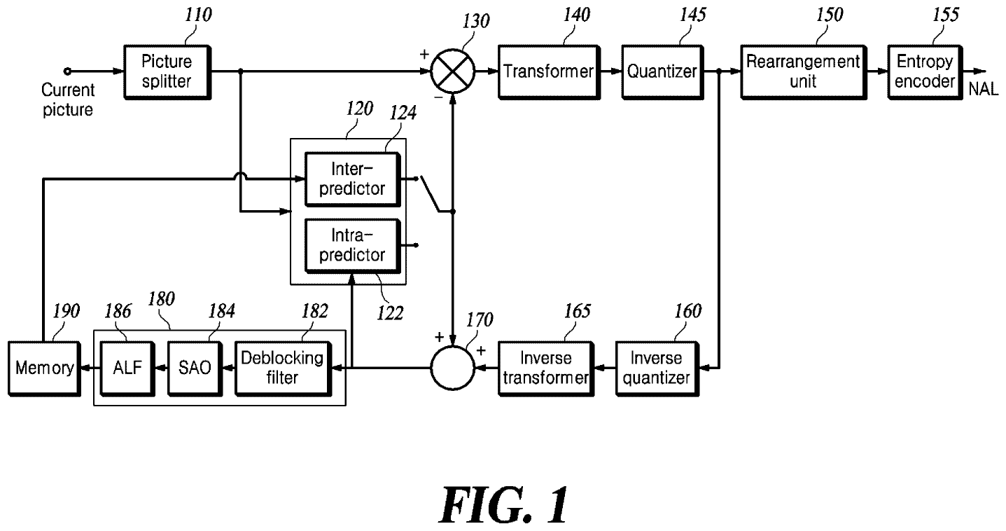

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binary tree (BT) in which the higher node is split into two lower nodes. The tree structure may also be a ternary tree (TT) in which the higher node is split into three lower nodes at a ratio of 1:2:1. The tree structure may also be a structure in which two or more structures among the QT structure, the BT structure, and the TT structure are mixed. For example, a quadtree plus binary tree (QTBT) structure may be used or a quadtree plus binary tree ternary tree (QTBTTT) structure may be used. Here, a binary tree ternary tree (BTTT) is added to the tree structures to be referred to as a multiple-type tree (MTT).

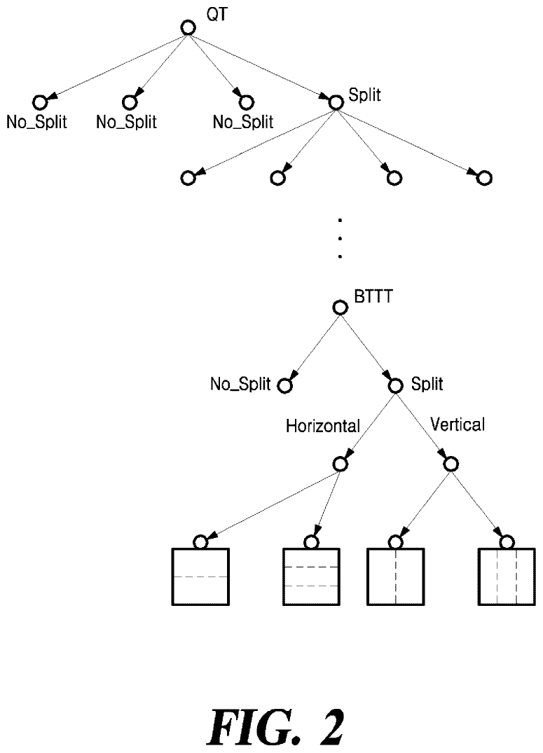

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

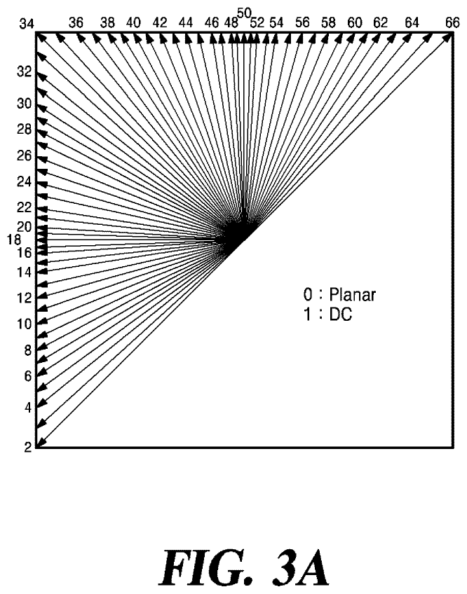

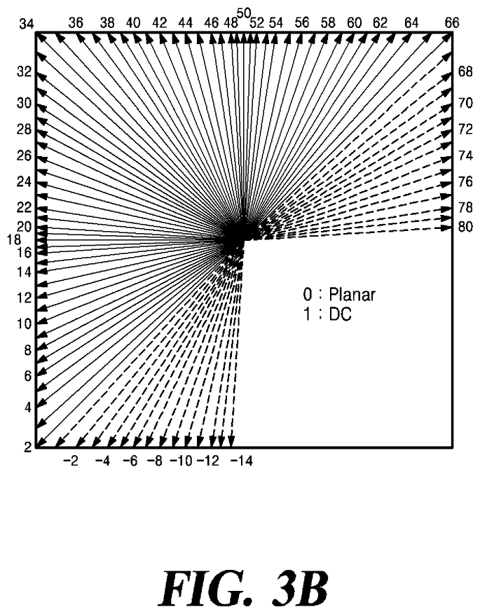

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

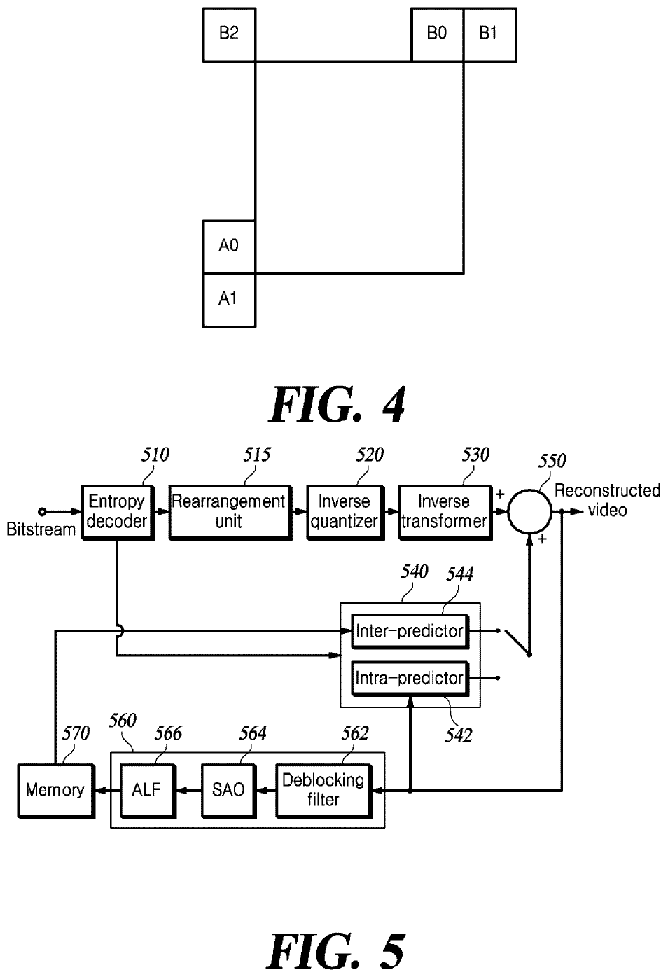

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for generating two intra predictors by using two different intra-prediction modes. The video coding method and the apparatus weight summing the two intra predictors by using pixel-wise weights based on a geometric block partition, thereby generating a final intra predictor.

The following embodiments may be performed by the intra predictor 122 in the video encoding apparatus, and the intra predictor 542 in the video decoding apparatus.

The video encoding apparatus when performing the intra prediction of the current block, may generate signaling information related to the present embodiment in terms of optimizing rate-distortion. The video encoding apparatus may encode the signaling information by using the entropy encoder 155 and may transmit it to the video decoding apparatus. The video decoding apparatus may decode the signaling information from the bitstream by using the entropy decoder 510.

In the following description, the term “target block” may be used interchangeably with the current block or coding unit (CU) as described above, or the ‘target block’ may mean a partial region of the coding unit.

Further, a value of true for a flag indicates a case of setting the flag to 1. Additionally, a value of false for a flag indicates a case of setting the flag to 0.

### I. Intra-Prediction Mode and Most Probable Mode (MPM)

Intra prediction, as described above, is a method of predicting the current block to be encoded by referring to samples that exist in the neighborhood of the current block. In the Versatile Video Coding (VVC) technique, the intra-prediction mode has subdivided directional modes (i.e., 2 to 66) in addition to non-directional (i.e., planar and DC) modes, as illustrated in FIG. 3A. Furthermore, as added to the example in FIG. 3B, the intra-prediction mode of the luma block has directional modes (−14 to −1 and 67 to 80) according to wide-angle intra prediction (WAIP).

For intra prediction, the most probable mode (MPM) technique utilizes the intra-prediction modes of neighbor blocks to intra-predict the current block. The video encoding apparatus generates an MPM list to include intra-prediction modes derived from predefined locations spatially adjacent to the current block. The video encoding apparatus may transmit the index of the MPM list in place of the index of the prediction mode and thereby improve the coding efficiency of the intra-prediction mode.

### II. Embodiments According to Present Disclosure

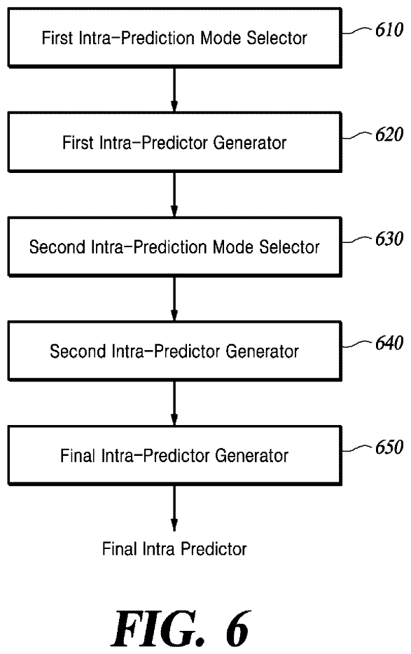

FIG. 6 is a block diagram illustrating an intra-predictor generation device, according to at least one embodiment of the present disclosure.

In applying a geometric intra-prediction mode, the intra-predictor generation device (hereinafter, “predictor generation device”) according to this embodiment generates two intra predictors by using two different intra-prediction modes for the current block, and then performs a blending process based on pixel-wise weights to generate a final intra predictor. The predictor generation device includes all or part of a first intra-prediction mode selector 610, a first intra-predictor generator 620, a second intra-prediction mode selector 630, a second intra-predictor generator 640, and a final intra-predictor generator 650.

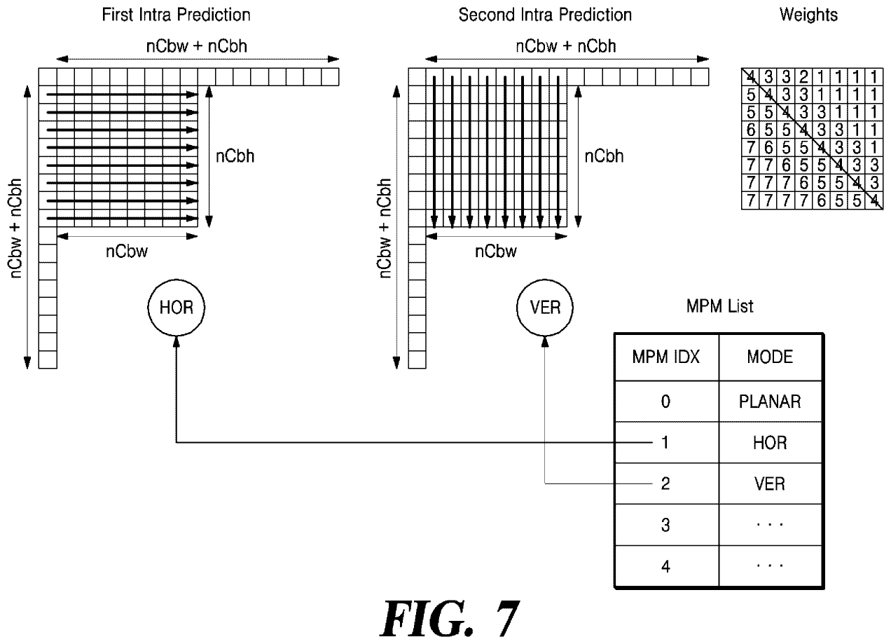

FIG. 7 is a diagram illustrating the application of a geometric intra-prediction mode, according to at least one embodiment of the present disclosure.

When applying the geometric intra-prediction mode, as illustrated in FIG. 7, the predictor generation device first generates a first intra predictor and a second intra predictor by using different intra-prediction modes for the current block. The predictor generation device may generate a final intra predictor by weight summing the first intra predictor and the second intra predictor by using weights based on the geometric block partition. In the example of FIG. 7, nCbw and nCbh represent the width and the height of the current block, respectively.

In the example of FIG. 7, the weights represent the weights for the first intra predictor. The meaning and setting of the weights are described below.

In one example, the first intra predictor may be a signal generated by using one intra-prediction mode in the MPM list as described above. The second intra predictor may also be a signal generated by using one intra-prediction mode of the other remaining modes in the MPM list than the intra-prediction mode used to generate the first intra predictor.

The following describes the operation of components in the predictor generation device in terms of the video decoding apparatus. As described above, the predictor generation device may also be included in the video encoding apparatus.

The first intra-prediction mode selector 610 generates an MPM list for intra prediction for the current block. The first intra-prediction mode selector 610 uses the index information signaled from the video encoding apparatus to select the intra-prediction mode indicated by the corresponding index in the MPM list.

Based on the first intra-prediction mode, the first intra-predictor generator 620 generates the first intra predictor of the current block by using the already reconstructed pixels spatially adjacent to the current block.

The second intra-prediction mode selector 630 reorders the MPM list by excluding the first intra-prediction mode from the MPM list. The second intra-prediction mode selector 630 uses the index information signaled from the video encoding apparatus to select the intra-prediction mode indicated by the corresponding index in the reordered MPM list.

Based on the second intra-prediction mode, the second intra-predictor generator 640 generates the second intra predictor of the current block by using the already reconstructed pixels spatially adjacent to the current block.

The final intra-predictor generator 650 obtains geometric block partitioning information, such as from a lookup table, by using the index signaled by the video encoding apparatus. The final intra-predictor generator 650 generates weights based on the geometric block partition information. Here, the weights include weights w1 for the first intra predictor and weights w2 for the second intra predictor. The final intra-predictor generator 650 utilizes the weights for generating a final intra predictor by performing a weighted sum of the first intra predictor and the second intra predictor. In this case, the aforementioned weights may be different values pixel-by-pixel according to the geometric block partition information.

The syntax signaled from the video encoding apparatus to the video decoding apparatus in relation to the geometric intra-prediction mode applied to the current block, i.e., the coding unit, may be represented as shown in Table 1.

```
TABLE 1
coding_unit( x0, y0, cbWidth, cbHeight, cqtDepth, treeType,
modeType ) {
  ...
    if( sps_mip_enabled_flag )
      intra_mip_flag
    if( intra_mip_flag ) {
      intra_mip_transposed_flag[ x0 ][ y0 ]
      intra_mip_mode[ x0 ][ y0 ]
    } else {
      if( sps_gim_enable_flag )
        intra_gim_flag
      if( intra_gim_flag ) {
        intra_gim_partition_flag
        intra_gim_idx0
        intra_gim_idx1
      } else {
        if( sps_mrl_enabled_flag && ( ( y0 % CtbSizeY ) > 0 ) )
          intra_luma_ref_idx
          ...
      }
    }
  ...
}
```

As shown in Table 1, when not in matrix-weighted intra prediction (MIP) mode, information on the geometric intra-prediction mode of the current block may be signaled. The information on the geometric intra-prediction mode may be signaled by using the following syntax elements.

First, a high-level syntax may be used to signal a flag, sps_gim_enable_flag to indicate whether the geometric intra-prediction mode is enabled. The example shown in Table 1 utilizes, but is not limited to, SPS among high-level syntaxes for the signaling. Namely, the use or non-use of geometric intra-prediction mode may be signaled in one or more of various high-level syntaxes such as SPS, PPS, slice header, picture header, and the like.

If the flag sps_gim_enable_flag is true and the geometric intra-prediction mode is used, the geometric intra-prediction flag of ‘intra_gim_flag’ may be signaled to indicate whether the geometric intra-prediction mode is enabled for the coding unit.

Then, if the value of intra_gim_flag is true and the coding unit uses the geometric intra-prediction mode, further information regarding the geometric intra-prediction mode may be signaled or parsed.

On the other hand, if the value of intra_gim_flag is false and the coding unit does not use the geometric intra-prediction mode, further information regarding the intra-prediction mode may be signaled or parsed according to conventional methods.

If the value of the geometric intra-prediction flag of ‘intra_gim_flag’ is true, the further information signaled may include a geometric partitioning information index of ‘intra_gim_partition_idx’ indicating a geometric partitioning form applied to the coding unit, a first intra-prediction mode index of ‘intra_gim_idx0’ indicating the first intra-prediction mode, and a second intra-prediction mode index of ‘intra_gim_idx1’ indicating the second intra-prediction mode.

Alternatively, the further information may be signaled or parsed in the order of ‘intra_gim_partition_idx’, the index indicating the geometric partitioning form, ‘intra_gim_idx0’, the index indicating the first intra-prediction mode, and ‘intra_gim_idx1’, the index indicating the second intra-prediction mode, such as the order exemplified in Table 1, but the signaling or parsing order is not necessarily limited thereto. In other words, variations in the signaling or parsing order may also be included in the scope of the present disclosure. For example, further information may be signaled or parsed in the order of the index indicating the first intra-prediction mode, the index indicating the second intra-prediction mode, and the index indicating the geometric partitioning form.

According to Table 1, among the information on the geometric intra-prediction mode, information on the geometric partitioning form applied to the coding unit is signaled or parsed by using its indicating index of ‘intra_gim_partition_idx’. Such information on the geometric partitioning form may include information on the bisection of a block. In this case, the bisection of a block may include partitioning the block by using a predefined straight line. This information on the geometric partitioning form is described in more detail below.

According to Table 1, the index indicating the first intra-prediction mode and the index indicating the second intra-prediction mode may be further signaled. In one example, the first intra-prediction mode and the second intra-prediction mode may be two different intra-prediction modes among all intra-prediction modes supported by the encoding and decoding process.

In another example, the first intra-prediction mode and the second intra-prediction mode may be two different intra-prediction modes among the intra-prediction modes included in a candidate list derived from predefined locations spatially adjacent to the current block. In this case, the candidate list may be an MPM list. Namely, the first intra-prediction mode and the second intra-prediction mode according to the present disclosure may be defined as prediction modes selected from a candidate list of predefined intra-prediction modes.

As another example, the syntax signaled from the video encoding apparatus to the video decoding apparatus in relation to the geometric intra-prediction mode may be represented as shown in Table 2.

```
TABLE 2
if( sps_mip_enabled_flag )
  intra_mip_flag
if( intra_mip_flag ) {
  intra_mip_transposed_flag[ x0 ][ y0 ]
  intra_mip_mode[ x0 ][ y0 ]
} else {
  if( sps_mrl_enabled_flag && ( ( y0 % CtbSizeY ) > 0 ) )
    intra_luma_ref_idx
  if( sps_isp_enabled_flag && intra_luma_ref_idx == 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag == 1 )
    intra_subpartitions_split_flag
  if( intra_luma_ref_idx == 0 )
    intra_luma_mpm_flag[ x0 ][ y0 ]
  if( intra_luma_mpm_flag[ x0 ][ y0 ] ) {
    if( intra_luma_ref_idx == 0 )
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
  if( sps_gim_enable_flag )
    intra_gim_flag
  if( intra_gim_flag ) {
    intra_gim_partition_flag
    intra_gim_idx1
  }
}
```

As shown in Table 2, when not in MIP mode, information on the geometric intra-prediction mode may be signaled after information on the intra-prediction mode is signaled according to conventional methods. The information on the geometric intra-prediction mode may be signaled by using the following syntax elements.

First, a high-level syntax may be used to signal a flag of ‘sps_gim_enable_flag’ to indicate whether the geometric intra-prediction mode is enabled.

If the flag of ‘sps_gim_enable_flag’ is true and the geometric intra-prediction mode is used, a geometric intra-prediction flag of ‘intra_gim_flag’ may be signaled for the coding unit, indicating whether the geometric intra-prediction mode is enabled.

If the value of the geometric intra-prediction flag of ‘intra_gim_flag’ is true, the further information signaled may include a geometric partitioning information index of ‘intra_gim_partition_idx’ indicating the geometric partitioning form applied to the coding unit, and a second intra-prediction mode index of ‘intra_gim_idx1’ indicating the second intra-prediction mode. In this case, the first intra-prediction mode index of ‘intra_gim_idx0’ indicating the first intra-prediction mode may indicate an earlier parsed intra-prediction mode (e.g., ‘intra_luma_mpm_idx’ or ‘intra_luma_mpm_remainder’) according to the default method.

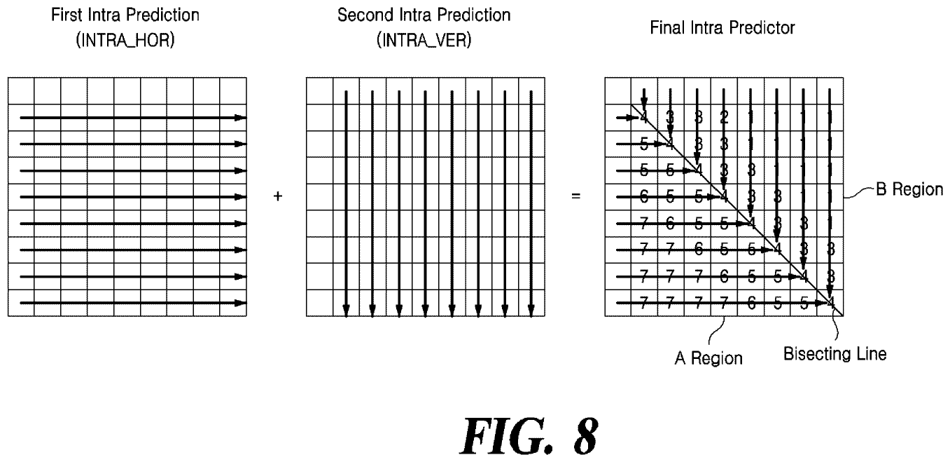

FIG. 8 is a diagram illustrating the blending processing of two predictors, according to at least one embodiment of the present disclosure.

As illustrated in FIG. 8, after selecting two different intra-prediction modes for the current block, the predictor generation device generates intra predictors corresponding to the respective intra-prediction modes. The predictor generation device generates a final intra predictor by weight summing the two intra predictors. In performing the weighted summing, the predictor generation device may blend the two intra predictors relative to a bisecting straight line that performs a geometric block partition for an arbitrary form of block partitioning. In other words, the predictor generation device may perform a blending process that weight sums differently for each of the pixels in the block to generate the final intra predictor from the two intra predictors.

Meanwhile, in performing different weighted summing pixel-by-pixel in a block relative to the straight line, the sum of the weights applied to pixels co-located in the two intra predictors is 1. In this case, the set containing the weights may be {0, 1, 2, 3, 4, 5, 6, 7, 8}, or the aforementioned set may be {0, ⅛, 2/8, ⅜, 4/8, ⅝, 6/8, ⅞, 1} with the scaling value considered. For example, at the (x,y) pixel location in the current block, when the weight of the first intra predictor is 1 (⅛ with the scaling value considered), the weight of the second intra predictor is 7 (⅞ with the scaling value considered).

In the example of FIG. 8, the weights expressed as integers for the final intra predictor represent the weights for the first intra predictor.

Furthermore, the bisecting straight line indicates a boundary where the size changes between the weights of the first intra predictor and the weights of the first intra predictor. For example, in the example of FIG. 8, for pixels included in region A relative to the straight line, the weights of the first intra predictor may be greater than or equal to the weights of the second intra predictor. Further, for pixels included in region B relative to the baseline, the weight of the second intra predictor may be greater than or equal to the weight of the first intra predictor.

Hereinafter, the predictor utilizing the larger weight in each region is referred to as the main predictor. These main predictors may be determined by considering the reference samples utilized for intra prediction. With region A illustrated in FIG. 8, the first intra predictor may be set as the main predictor because it is closer to the left reference samples than the top reference samples.

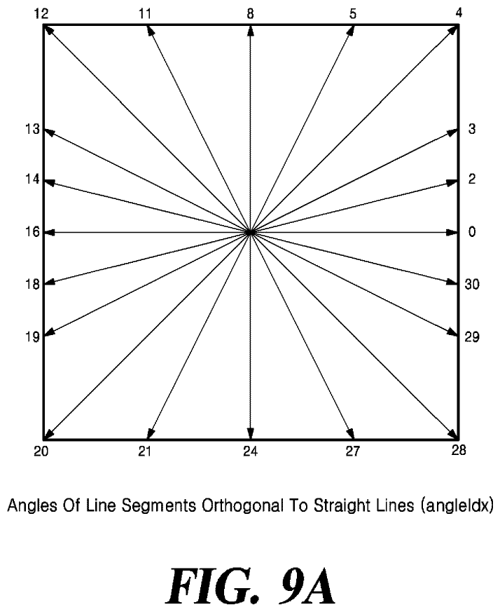

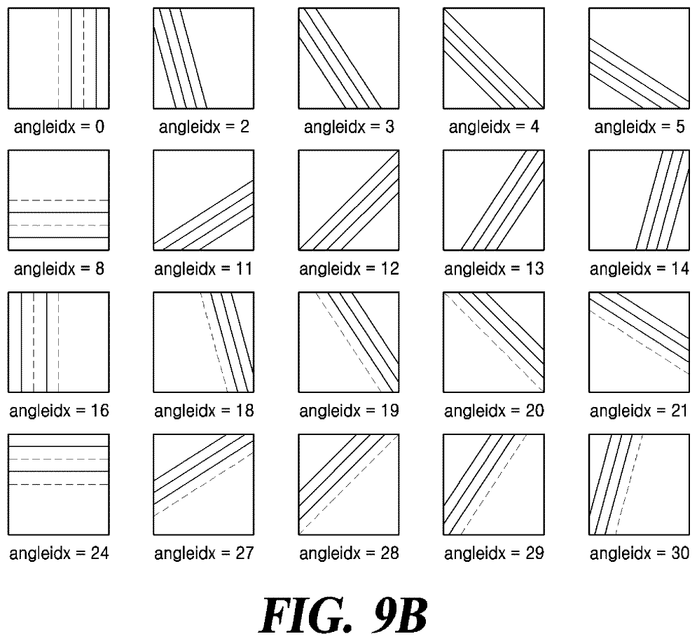

FIGS. 9A and 9B are illustrative diagrams depicting straight lines bisecting a block, according to at least one embodiment of the present disclosure.

For a block encoded/decoded according to the geometric intra-prediction mode, the geometric partitioning form is based on a straight line representing a bisection of the block. Information on such a straight line may include an index of ‘distanceIdx’ indicating a distance from the center of the block to the relevant straight line, and an index of ‘angleIdx’ indicating an angle of a line segment orthogonal to the relevant straight line. The index indicating the angle of the line segment orthogonal to the relevant straight line may be set as illustrated in FIG. 9A. Further, the 64 geometric block partition forms based on these angles and distances may be set as illustrated in FIG. 9B.

The 64 geometric partitioning forms may be signaled by using the ‘intra_gim_partitionidx’ syntax which is an index indicating the geometric partitioning forms, as shown in Table 3.

TABLE 3

| intra_gim_partition_idx | 0 | 1 | 2 | 3 | 4 | 5 | 6 | 7 |
|---|---|---|---|---|---|---|---|---|
| angleIdx | 0 | 0 | 2 | 2 | 2 | 2 | 3 | 3 |
| distanceIdx | 1 | 3 | 0 | 1 | 2 | 3 | 0 | 1 |
| intra_gim_partition_idx | 8 | 9 | 10 | 11 | 12 | 13 | 14 | 15 |
| angleIdx | 3 | 3 | 4 | 4 | 4 | 4 | 5 | 5 |
| distanceIdx | 2 | 3 | 0 | 1 | 2 | 3 | 0 | 1 |
| intra_gim_partition_idx | 16 | 17 | 18 | 19 | 20 | 21 | 22 | 23 |
| angleIdx | 5 | 5 | 8 | 8 | 11 | 11 | 11 | 11 |
| distanceIdx | 2 | 3 | 1 | 3 | 0 | 1 | 2 | 3 |
| intra_gim_partition_idx | 24 | 25 | 26 | 27 | 28 | 29 | 30 | 31 |
| angleIdx | 12 | 12 | 12 | 12 | 13 | 13 | 13 | 13 |
| distanceIdx | 0 | 1 | 2 | 3 | 0 | 1 | 2 | 3 |
| intra_gim_partition_idx | 32 | 33 | 34 | 35 | 36 | 37 | 38 | 39 |
| angleIdx | 14 | 14 | 14 | 14 | 16 | 16 | 18 | 18 |
| distanceIdx | 0 | 1 | 2 | 3 | 1 | 3 | 1 | 2 |
| intra_gim_partition_idx | 40 | 41 | 42 | 43 | 44 | 45 | 46 | 47 |
| angleIdx | 18 | 19 | 19 | 19 | 20 | 20 | 20 | 21 |
| distanceIdx | 3 | 1 | 2 | 3 | 1 | 2 | 3 | 1 |
| intra_gim_partition_idx | 48 | 49 | 50 | 51 | 52 | 53 | 54 | 55 |
| angleIdx | 21 | 21 | 24 | 24 | 27 | 27 | 27 | 28 |
| distanceIdx | 2 | 3 | 1 | 3 | 1 | 2 | 3 | 1 |
| intra_gim_partition_idx | 56 | 57 | 58 | 59 | 60 | 61 | 62 | 63 |
| angleIdx | 28 | 28 | 29 | 29 | 29 | 30 | 30 | 30 |
| distanceIdx | 2 | 3 | 1 | 2 | 3 | 1 | 2 | 3 |

The index of ‘distanceIdx’ that is derived from the example of FIG. 9B is a value that excludes the size of the current block. Thus, the actual distance between the pixel in the current block and the straight line may be calculated by using the size information of the current block, the index of ‘angleIdx’ indicating the angle, and the index of ‘distanceIdx’ indicating the distance. Here, the actual distance is a value expressed in pixel units.

Further, the actual distance may be used to calculate a weight for each of the pixels in the current block. For example, for a pixel in the current block, the greater the actual distance between the pixel and the straight line, the greater the weight of the main predictor as described above and the smaller the weight of the other predictor remaining. For pixels that lie on the straight line, the two predictors may have the same weight. In this case, the sum of the weights of the two predictors for a pixel remains to be 1.

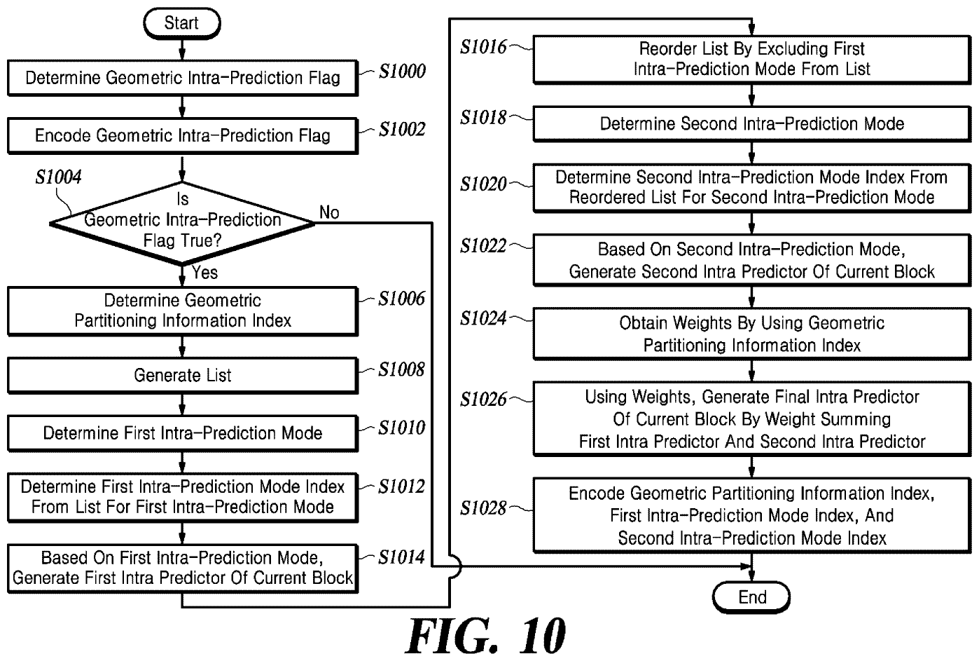

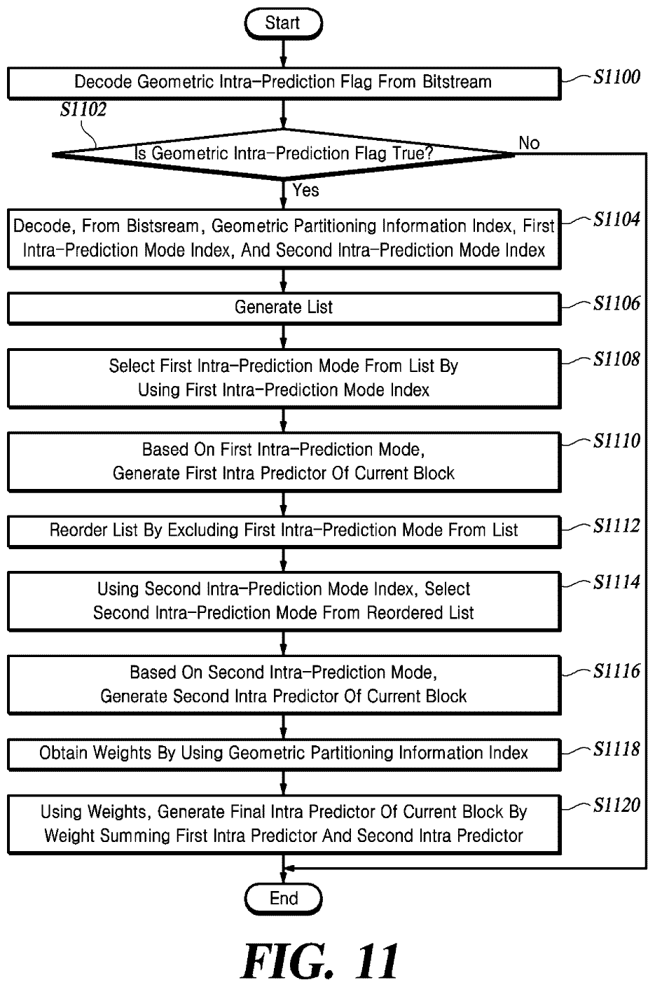

Referring now to FIGS. 10 and 11, an intra prediction method utilizing a geometric intra-prediction mode is described.

FIG. 10 is a flowchart of an intra prediction method performed by the video encoding apparatus, according to at least one embodiment of the present disclosure.

The video encoding apparatus determines a geometric intra-prediction flag (S1000). Here, the geometric intra-prediction flag of ‘intra_gim_flag’ indicates whether to use the geometric intra-prediction mode for the current block. The video encoding apparatus may determine the use of the geometric intra-prediction flag in terms of optimizing rate-distortion, as described above.

The video encoding apparatus encodes the geometric intra-prediction flag (S1002).

The video encoding apparatus checks for the geometric intra-prediction flag (S1004).

If the geometric intra-prediction flag is true (Yes in S1004), the video encoding apparatus performs the following steps.

The video encoding apparatus determines a geometric partitioning information index (S1006). Here, the geometric partitioning information index of ‘intra_gim_partition_idx’ indicates a geometric partitioning form applied to the current block. In other words, the geometric partitioning information index indexes information on a straight line bisecting the current block.

The video encoding apparatus generates a list including intra-prediction modes for intra prediction of the current block (S1008). Here, the list may be an MPM list. Alternatively, the list may be a list including all intra-prediction modes.

The video encoding apparatus determines the first intra-prediction mode in terms of optimizing the coding rate (S1010).

The video encoding apparatus determines a first intra-prediction mode index from the list for the first intra-prediction mode (S1012). The first intra-prediction mode index of ‘intra_gim_idx0’ indexes the first intra-prediction mode. For example, if the MPM list does not include the first intra-prediction mode, the first intra-prediction mode index may be determined from the list including all intra-prediction modes.

Based on the first intra-prediction mode, the video encoding apparatus generates a first intra predictor of the current block by using pixels spatially adjacent to the current block (S1014).

The video encoding apparatus reorders the list by excluding the first intra-prediction mode from the list (S1016).

The video encoding apparatus determines a second intra predictor in terms of optimizing the coding rate (S1018).

The video encoding apparatus determines a second intra-prediction mode index from the reordered list for the second intra-prediction mode (S1020). The second intra-prediction mode index of ‘intra_gim_idx1’ indexes the second intra-prediction mode. For example, if the reordered MPM list does not include the second intra-prediction mode, the second intra-prediction mode index may be determined from the list including all intra-prediction modes.

Based on the second intra-prediction mode, the video encoding apparatus generates a second intra predictor of the current block by using pixels spatially adjacent to the current block (S1022).

The video encoding apparatus obtains the weights by using the geometric partitioning information index (S1024). Here, the weights include the first weights for the first intra predictor, and the second weights for the second intra predictor.

The information on the straight line according to the geometric partitioning information index may include an index of ‘distanceIdx’ indicating the distance from the center of the block to the relevant straight line, and an index of ‘angleIdx’ indicating the angle of a line segment orthogonal to the relevant straight line. Using the size information of the current block, the index of ‘angleIdx’ representing the angle, and the index of ‘distanceIdx’ indicating the distance, the actual distance may be calculated between the pixels in the current block and the straight line. Based on these actual distances, weights may be calculated for the pixels in the current block.

The video encoding apparatus utilizes the weights to generate a final intra predictor of the current block by weight summing the first intra predictor and the second intra predictor (S1026).

The video encoding apparatus encodes the geometric partitioning information index, the first intra-prediction mode index, and the second intra-prediction mode index (S1028).

If the geometric intra-prediction flag is false (No in S1004), the geometric intra prediction is omitted for the current block. In this case, the video encoding apparatus may perform intra prediction of the current block by using another intra-prediction mode.

FIG. 11 is a flowchart of an intra prediction method performed by the video decoding apparatus, according to at least one embodiment of the present disclosure.

The video decoding apparatus decodes a geometric intra-prediction flag from the bitstream (S1100). Here, the geometric intra-prediction flag of ‘intra_gim_flag’ indicates whether the geometric intra-prediction mode is to be used for the current block. As described above, the use of the geometric intra-prediction flag may be determined by the video encoding apparatus in terms of optimizing rate-distortion.

The video decoding apparatus checks for the geometric intra-prediction flag (S1102).

If the geometric intra-prediction flag is true (Yes in S1102), the video decoding apparatus performs the following steps.

The video decoding apparatus decodes, from the bitstream, the geometric partitioning information index, the first intra-prediction mode index, and the second intra-prediction mode index (S1104). Here, the geometric partitioning information index of ‘intra_gim_partition_idx’ indicates the geometric partitioning form applied to the current block. Namely, the geometric partitioning information index indexes information on the straight line that bisects the current block. The first intra-prediction mode index of ‘intra_gim_idx0’ indexes the first intra-prediction mode. Additionally, the second intra-prediction mode index of ‘intra_gim_idx1’ indexes the second intra-prediction mode.

The video decoding apparatus generates a list including prediction modes for intra prediction of the current block (S1106). Here, the list may be an MPM list. Alternatively, the list may be a list including all intra-prediction modes.

The video decoding apparatus selects the first intra-prediction mode from the list by using the first intra-prediction mode index (S1108). For example, if the first intra-prediction mode index does not indicate an intra-prediction mode in the MPM list, the first intra-prediction mode may be selected from the list including all intra-prediction modes.

Based on the first intra-prediction mode, the video decoding apparatus generates a first intra predictor of the current block by using pixels spatially adjacent to the current block (S1110).

The video decoding apparatus reorders the list by excluding the first intra-prediction mode from the list (S1112).

The video decoding apparatus selects a second intra predictor from the reordered list by using the second intra-prediction mode index (S1114). For example, if the second intra-prediction mode index does not indicate an intra-prediction mode in the reordered MPM list, the second intra-prediction mode may be selected from the list including all intra-prediction modes.

Based on the second intra-prediction mode, the video decoding apparatus generates a second intra predictor of the current block by using pixels spatially adjacent to the current block (S1116).

The video decoding apparatus obtains the weights by using the geometric partitioning information index (S1118). Here, the weights include the first weights for the first intra predictor, and the second weights for the second intra predictor.

The information on the straight line according to the geometric partitioning information index may include an index of ‘distanceIdx’ indicating the distance from the center of the block to the relevant straight line, and an index of ‘angleIdx’ indicating the angle of a line segment orthogonal to the relevant straight line. Using the size information of the current block, the index of ‘angleIdx’ indicating the angle, and the index of ‘distanceIdx’ indicating the distance, the actual distance may be calculated between the pixel in the current block and the straight line. Based on these actual distances, weights may be calculated for the pixels in the current block.

Using the weights, the video decoding apparatus may weight sum the first intra predictor and the second intra predictor to generate a final intra predictor of the current block (S1120).

If the geometric intra-prediction flag is false (No in S1102), the geometric intra-prediction is omitted for the current block. In this case, the video decoding apparatus may utilize another intra-prediction mode to perform intra prediction of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

What is claimed is:

1. A method performed by a video decoding apparatus for intra-predicting a current block, the method comprising:
decoding, from a bitstream, a geometric intra-prediction flag that indicates whether to use a geometric intra-prediction mode for the current block; and
checking for the geometric intra-prediction flag,
wherein if the geometric intra-prediction flag is true, the method further comprises:
decoding from the bitstream a geometric partitioning information index, a first intra-prediction mode index, and a second intra-prediction mode index;
selecting a first intra-prediction mode from a list of prediction modes by using the first intra-prediction mode index;
generating, based on the first intra-prediction mode, a first intra predictor of the current block by using pixels spatially adjacent to the current block;
selecting a second intra-prediction mode from the list of prediction modes by using the second intra-prediction mode index;
generating, based on the second intra-prediction mode, a second intra predictor of the current block by using pixels spatially adjacent to the current block;
obtaining, by using the geometric partitioning information index, weights that comprise first weights used for the first intra predictor and second weights used for the second intra predictor; and
weight summing the first intra predictor and the second intra predictor by using the weights to generate a final intra predictor of the current block.

2. The method of claim 1, further comprising:
generating the list comprising prediction modes for intra prediction of the current block.

3. The method of claim 1, further comprising:
reordering the list of prediction modes by excluding the first intra-prediction mode from the list of prediction modes.

4. The method of claim 1, wherein obtaining the weights comprises:
obtaining, by using the geometric partitioning information index, an index of angle and an index of distance relative to a straight line bisecting the current block, the index of angle representing an angle of a line segment orthogonal to the straight line, and the index of distance representing a distance from the straight line.

5. The method of claim 4, wherein obtaining the weights comprises:
calculating actual distances between pixels in the current block and the straight line by using a size of the current block, the index of angle, and the index of distance.

6. The method of claim 5, wherein obtaining the weights comprises:
calculating, based on the actual distances, the first weights and the second weights for the pixels in the current block,
wherein, for each of the pixels in the current block, a sum of a weight of the first intra predictor and a weight of the second intra predictor is one.

7. The method of claim 4, wherein obtaining the weights comprises:
determining, based on reference samples used for the intra prediction, a predictor that uses a greater weight in each of regions of the current block once bisected along the straight line.

8. A method performed by a video encoding apparatus for intra-predicting a current block, the method comprising:
determining a geometric intra-prediction flag that indicates whether to use a geometric intra-prediction mode for the current block; and
checking for the geometric intra-prediction flag,
wherein if the geometric intra-prediction flag is true, the method further comprises:
determining a geometric partitioning information index;
determining a first intra-prediction mode;
determining, for the first intra-prediction mode, a first intra-prediction mode index from a list of intra-prediction modes;
generating, based on the first intra-prediction mode, a first intra predictor of the current block by using pixels spatially adjacent to the current block;
determining a second intra-prediction mode;
determining, for the second intra-prediction mode, a second intra-prediction mode index from the list of intra-prediction modes;
generating, based on the second intra-prediction mode, a second intra predictor of the current block by using pixels spatially adjacent to the current block;
obtaining, by using the geometric partitioning information index, weights that comprise first weights used for the first intra predictor and second weights used for the second intra predictor; and
weight summing the first intra predictor and the second intra predictor by using the weights to generate a final intra predictor of the current block.

9. The method of claim 8, further comprising:
generating the list comprising intra-prediction modes for intra prediction of the current block.

10. The method of claim 8, further comprising:
reordering the list of intra-prediction modes by excluding the first intra-prediction mode from the list of intra-prediction modes.

11. The method of claim 8, further comprising:
encoding the geometric intra-prediction flag.

12. The method of claim 11, further comprising, if the geometric intra-prediction flag is true:
encoding the geometric partitioning information index, the first intra-prediction mode index, and the second intra-prediction mode index.

13. A non-transitory computer-readable recording medium storing a bitstream generated by a video encoding method, the video encoding method comprising:
determining a geometric intra-prediction flag that indicates whether to use a geometric intra-prediction mode for a current block; and
checking for the geometric intra-prediction flag,
wherein if the geometric intra-prediction flag is true, the video encoding method further comprising:
determining a geometric partitioning information index;
determining a first intra-prediction mode;
determining, for the first intra-prediction mode, a first intra-prediction mode index from a list of intra-prediction modes;
generating, based on the first intra-prediction mode, a first intra predictor of the current block by using pixels spatially adjacent to the current block;
determining a second intra-prediction mode;
determining, for the second intra-prediction mode, a second intra-prediction mode index from the list of intra-prediction modes;
generating, based on the second intra-prediction mode, a second intra predictor of the current block by using pixels spatially adjacent to the current block;
obtaining, by using the geometric partitioning information index, weights that comprise first weights used for the first intra predictor and second weights used for the second intra predictor; and
weight summing the first intra predictor and the second intra predictor by using the weights to generate a final intra predictor of the current block.

14. The non-transitory computer-readable recording medium of claim 13, wherein if the geometric intra-prediction flag is true, the video encoding method further comprises:
generating the list comprising intra-prediction modes for intra prediction of the current block.

15. The non-transitory computer-readable recording medium of claim 13, wherein if the geometric intra-prediction flag is true, the video encoding method further comprises:
reordering the list of intra-prediction modes by excluding the first intra-prediction mode from the list of intra-prediction modes.

16. The non-transitory computer-readable recording medium of claim 13, wherein if the geometric intra-prediction flag is true, the video encoding method further comprises:
encoding the geometric intra-prediction flag.

17. The non-transitory computer-readable recording medium of claim 16, wherein if the geometric intra-prediction flag is true, the video encoding method further comprises:
encoding the geometric partitioning information index, the first intra-prediction mode index, and the second intra-prediction mode index.
